(19) United States
(12) Patent Application Publication
(10) Pub. No.: US 2019/0091558 A1
(43) Pub. Date: Mar. 28, 2019

(54) ENTERTAINMENT AND GAMING SYSTEMS AND METHODS

(71) Applicant: Robert Bealke, Brooklyn Park, MN (US)

(72) Inventor: Robert Bealke, Brooklyn Park, MN (US)

(21) Appl. No.: 16/206,752

(22) Filed: Nov. 30, 2018

Related U.S. Application Data
(63) Continuation-in-part of application No. 15/600,345, filed on May 19, 2017, now Pat. No. 10,155,151.

(51) Int. Cl. A63F 3/00; A63F 3/06; A63F 13/80

(52) U.S. Cl. CPC A63F 3/00119; A63F 2009/247; A63F 13/80; A63F 3/062

(57) ABSTRACT

The disclosure includes a method of selecting and playing a video playlist for a trivia-like game. The method may include determining a demographic of game players, distributing at least one playing card to each game player, and selecting a prearranged video playlist comprising a plurality of videos based upon the demographic of game players. In some embodiments, the method includes playing at least one video from the prearranged video playlist, whereby the at least one video may represent at least a portion of a plurality of questions for the trivia-like game.

### CROSS-REFERENCE TO RELATED APPLICATIONS

This application claims the benefit of and is a continuation-in-part of U.S. patent application Ser. No. 15/600,345; filed May 19, 2017; and entitled ENTERTAINMENT AND GAMING SYSTEMS AND METHODS. The entire contents of U.S. patent application Ser. No. 15/600,345 are incorporated herein by reference.

### BACKGROUND

### Field

Various embodiments disclosed herein relate to entertainment. Certain embodiments relate to games played in a bar or restaurant.

### Description of Related Art

Many bars and restaurants offer promotions and entertainment to attract customers to their establishments to increase sales. Specifically, many of these establishments provide games, such as trivia or bingo. Unfortunately, many of these games have become so commonplace and ordinary that they do not distinguish one establishment from another and therefore fail to attract customers. Additionally, many of these games require so much concentration from players that they then fail in their objective of trying to increase sales because customers are so riveted in the game that they don't purchase additional food and drinks. Thus, there is a need for entertainment and gaming systems and methods to attract customers and increase sales of bars and restaurants.

### SUMMARY

This disclosure includes methods of preparing and playing a music video playlist for a game. Methods can comprise determining an approximate number of players and selecting, via a computing device, a prearranged music video playlist comprising a plurality of music videos. A number of music videos contained within the prearranged music video playlist can be based upon the approximate number of players. Methods can also include playing, via a mixer and a display screen, a first music video from the predetermined music video playlist and queuing, via the mixer, a second music video from the predetermined music video playlist.

In some embodiments, the method includes queuing, via the mixer, the first music video from the predetermined music video playlist. Additionally, methods can include determining a demographic of the players. In some embodiments, a genre of music videos contained within the prearranged music video playlist is based upon the demographic of the players.

Methods may also include queuing, via the mixer, a first plurality of music videos from the predetermined music video playlist. As well, some methods may include playing, via the mixer and the display screen, the first plurality of music videos from the predetermined music video playlist. Additionally, methods may include continuing queuing and playing, via the mixer and the display screen, the first plurality of music videos from the predetermined music video playlist until a first player wins the game. Methods can also include awarding the first player a first prize in response to the first player winning the game. In some embodiments, the prearranged music video playlist ensures that the first player will win the game within a first predetermined amount of time.

Some methods may include queuing, via the mixer, a second plurality of music videos from the predetermined music video playlist and playing, via the mixer and the display screen, the second plurality of music videos from the predetermined music video playlist. Methods may also include continuing queuing and playing, via the mixer and the display screen, the second plurality of music videos from the predetermined music video playlist until a second player wins the game. Additionally, methods may include awarding the second player a second prize in response to the second player winning the game.

Methods can even include queuing, via the mixer, a third plurality of music videos from the predetermined music video playlist and playing, via the mixer and the display screen, the third plurality of music videos from the predetermined music video playlist. Some methods may include continuing queuing and playing, via the mixer and the display screen, the third plurality of music videos from the predetermined music video playlist until a third player wins the game. Accordingly, methods can include awarding the third player a third prize in response to the third player winning the game.

In some embodiments, the prearranged music video playlist ensures that the second player will win the game within a second predetermined amount of time and that the third player will win the game within a third predetermined amount of time.

Even still, in some embodiments, the plurality of music videos comprises a plurality of songs performed by a plurality of musicians. In some embodiments, each musician among the plurality of musicians has only one song among the plurality of songs.

Methods may even include distributing at least one playing card to each of the players. In some embodiments, the at least one playing card comprises a plurality of squares. A majority of the squares can comprise bibliographic information comprising at least one of a musician name and a song title.

In some embodiments, the plurality of squares is arranged in a rectangular pattern. In some embodiments, the plurality of squares comprises 25 squares.

Even still, in some embodiments, when the first player wins the game the first player has matched at least four music videos with at least four squares on a playing card. In some embodiments, the at least four squares comprise bibliographic information related to the at least four music videos. As well, in some embodiments, the at least four squares are arranged in a predetermined pattern.

Additionally, the disclosure includes a method of selecting and playing a video playlist for a trivia-like game. In many embodiments, the methods includes determining a demographic of game players; distributing at least one playing card to each game player; selecting, via a computing device, a prearranged video playlist comprising a plurality of videos based upon the demographic of game players; and playing, via a mixer and a display screen, a first video from the prearranged video playlist. The first video may represent at least a portion of a first question for the trivia-like game.

Methods may also include queuing, via the mixer, a first video from the prearranged video playlist and queuing, via the mixer, a second video from the prearranged video playlist. Accordingly, methods may also include playing, via the mixer and the display screen, a second video from the prearranged video playlist. It should be appreciated that the second video may represent at least a portion of a second question for the trivia-like game.

The plurality of questions may cause the game players to provide a plurality of numerical answers. As such, methods may include determining at least one numerical sum that corresponds to a summation of the plurality of numerical answers provided by the game players.

In some embodiments, at least one numerical sum ensures that at least one game player wins the trivia-like game. The at least one numerical sum may comprise at least one of a plurality of ranges of numerical values and a plurality of discrete numerical values. In some embodiments, the at least one numerical sum is equal to a plurality of discrete numerical values. However, in some embodiments, the at least one numerical sum is equal to one discrete numerical value.

The step of determining the at least one numerical sum may comprise determining an average numerical sum of a highest numerical answer and a lowest numerical answer as provided by the game players. Additionally, methods may include determining a high numerical sum range, a medium numerical sum range, and a low numerical sum range whereby the high numerical sum range, the medium numerical sum range, and the low numerical sum range all correspond to the numerical answers provided by the game players.

Methods may also include awarding a first prize to a first game player having a sum of numerical answers that fall within the high numerical sum range. Methods may even include awarding a second prize to a second game player having a sum of numerical answers that fall within the medium numerical sum range and awarding a third prize to a third game player having a sum of numerical answers that fall within the low numerical sum range.

Even still, methods may include determining a numerical sum range that corresponds to the numerical answers provided by the game players. Also, methods may include determining a discrete numerical sum that falls within the numerical sum range. Accordingly, methods may include awarding at least a first share of a game prize to a plurality of game players having a summation of numerical answers falling within the numerical sum range; and awarding at least a second share of a game prize to a first game player having a summation of numerical answers equal to the discrete numerical sum. In some embodiments, the second share is greater than the first share.

In some embodiments, the method includes selecting, via the computing device, a first video from the prearranged video playlist. Methods may thereby include determining a first modifier that corresponds to a numerical answer of the first video. The first modifier may be arranged and configured to eliminate at least one game player from eligibility for a prize. As well, methods may include selecting, via the computing device, a second video from the prearranged video playlist. Accordingly, methods may include determining a second modifier that corresponds to a numerical answer of the second video. The second modifier may be arranged and configured to eliminate at least one game player from eligibility for the prize.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates an entertainment system, according to some embodiments.

FIG. 2 illustrates a prearranged music video playlist, according to some embodiments.

FIG. 3 illustrates a playing card, according to some embodiments.

FIGS. 4-9 illustrate different winning configurations of playing cards, according to some embodiments.

FIGS. 10-12 illustrate flow charts for preparing and playing a music video playlist for a game, according to some embodiments.

FIGS. 13-16 illustrate flow charts for selecting and playing a video playlist for a trivia-like game, according to some embodiments.

FIG. 17 illustrates a playing card for the trivia-like game, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### LIST OF REFERENCE NUMERALS

10—Entertainment system
12—Computing device (e.g. laptop, smart phone, and/or tablet device)
14—Mixer (e.g. audio and/or video mixer)
16—Display screen (e.g. television)
18—Communication network
20—Prearranged music video playlist
22—Plurality of music videos
24—Plurality of songs
26—Playing card
28—Squares
40—First winning configuration
42—Second winning configuration
44—Third winning configuration
46—Fourth winning configuration
48—Fifth winning configuration
50—Sixth winning configuration

Introduction

This disclosure includes entertainment and gaming systems and methods that can help businesses, such as bars and restaurants, attract more customers and increase sales. The systems and methods disclosed herein can take elements from common games, such as trivia and bingo, and combine them with other entertainment medium, such as songs and music videos, and transform them into novel entertainment and gaming systems and methods. The resulting systems and methods may not only help bars and restaurants achieve their business objectives, but also provide customers an intriguing and social way of being entertained while patronizing said businesses.

Specifically, the entertainment and gaming systems and methods disclosed herein can be referred to as Vingo®. Similar to the traditional game of bingo, Vingo® is a game of chance in which a game participant, or player, listens to a song and/or watches a music video and then tries to identify the name of the musician or song title with musicians names and/or song titles pre-printed in different arrangements on a playing card, such as a 5×5 card. The songs and/or music videos are selected and played at random by a game host, such as a disc jockey. When a player identifies four or five musician's name and/or song titles on their playing card in a winning arrangement, they can call out “Vingo!” to alert all participants of their winning card, which prompts the game host to examine the playing card for verification of the win. Players can compete against one another to be the first to have a winning arrangement for the prize or jackpot. In some embodiments, after one winner is declared, the game is complete and a new round of play can begin. However, in some embodiments, the game is not complete until two or more winners are declared, whereby a new round of play can begin.

Entertainment and Gaming Systems

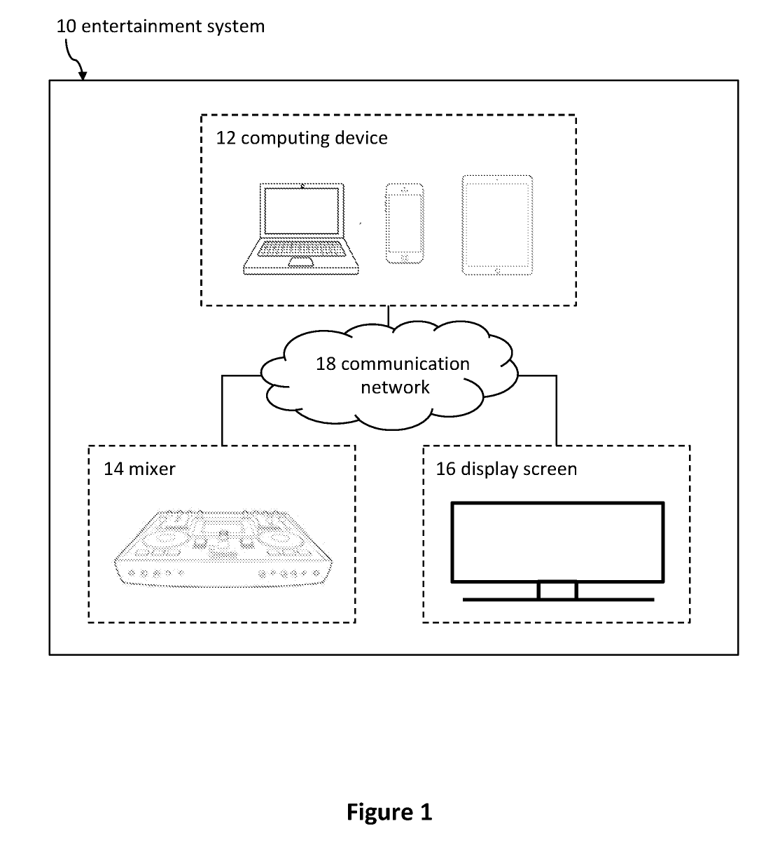

As shown in FIG. 1, the entertainment and gaming systems and methods can be implemented via entertainment system 10. The system 10 can include a computing device 12 communicatively coupled to a mixer 14 and a display screen 16, via a communication network 18. The computing device 12 can include any device, such as a laptop computer, desktop computer, smart phone, tablet device, and the like. Additionally, the mixer 14 can include an audio and/or video mixer, and the like. The display screen 16 can include a television, computer monitor, and any type screen that displays moving and/or still images. Moreover, the communication network 18 can comprise any type of wired or wireless network, such as radio, Wi-Fi (e.g., wireless local area network), cellular, Internet, Bluetooth, telecommunication, Ethernet, and the like.

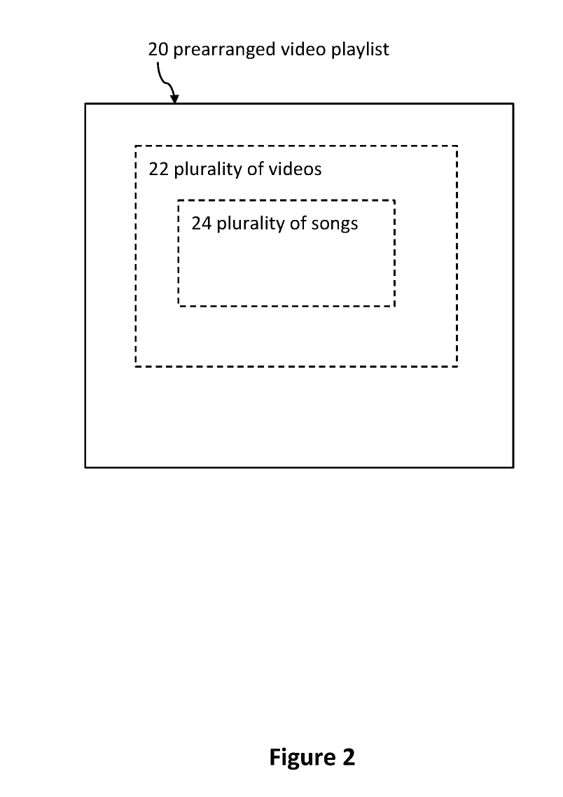

With reference to FIG. 2, the system 10 can also include a prearranged music video playlist 20, which can include a plurality of music videos 22. The plurality of music videos 22 can include a plurality of songs 24 performed by a plurality of musicians. In some embodiments, each musician among the plurality of musicians has only one song among the plurality of songs. The prearranged music video playlist 20 can be stored via the computing device 12, while the plurality of music videos 22 and the plurality of songs 24 can be selected and queued via the computing device 12 and the mixer 14 by a game host. Furthermore, the plurality of videos 22 and plurality of songs 24 can be played via the display screen 16 for the players to see and hear.

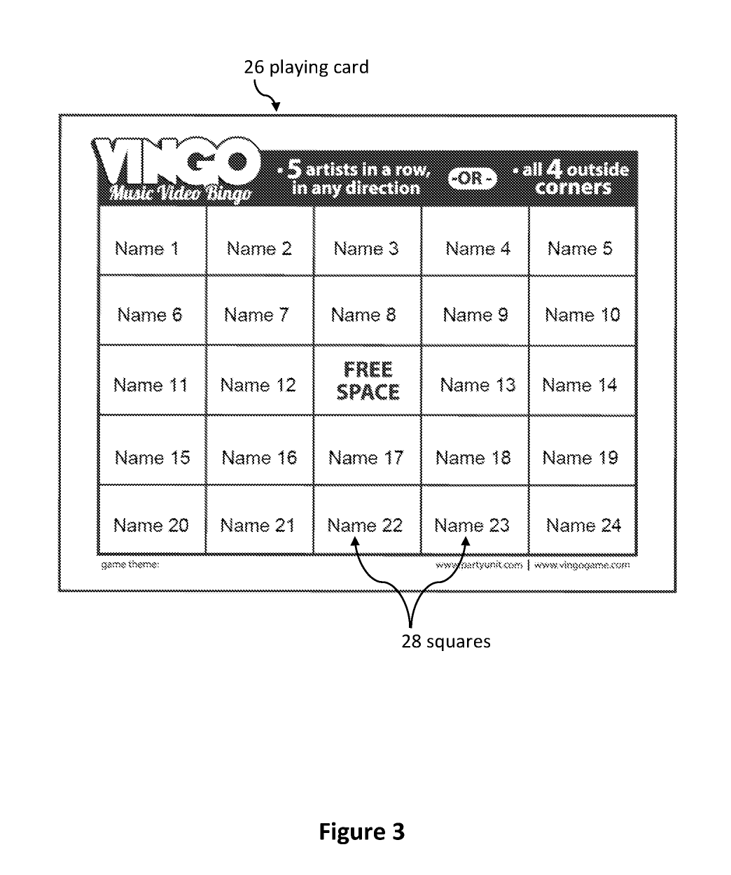

As illustrated in FIG. 3, the system 10 can also include a playing card 26. The playing card 26 can include a plurality of squares 28. In some embodiments, a majority of the squares 28 comprises bibliographic information (e.g. Name 1, Name 2, etc.) including information such as a musician name and/or a song title. In some embodiments, the plurality of squares includes 25-squares, whereby 24 of the 25-squares includes bibliographic information, with the 25^{th} square being a “free space” that is complimentary to the player. In some embodiments, the plurality of squares can be arranged in a pattern, such as a rectangular pattern.

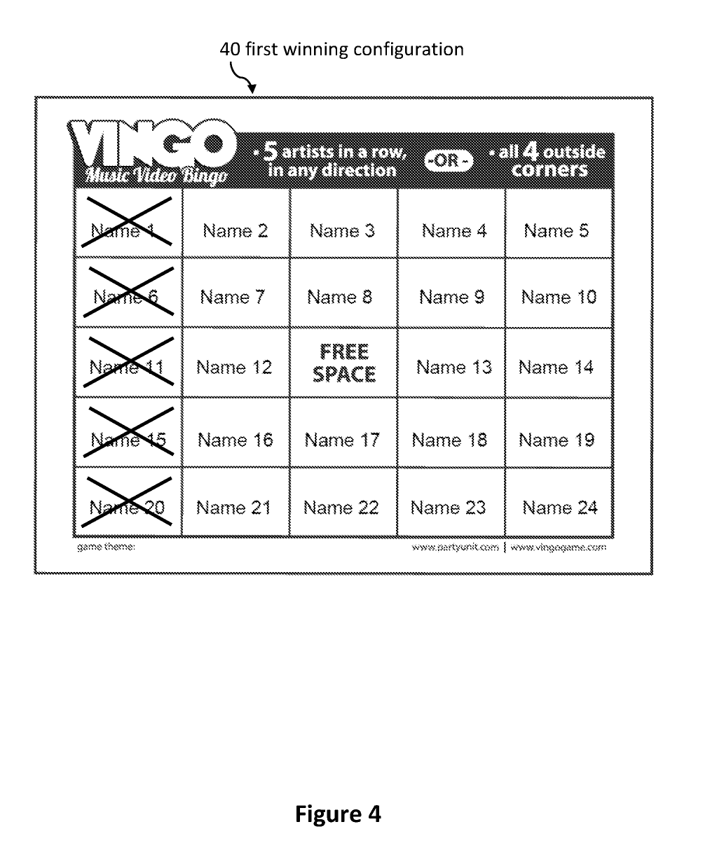

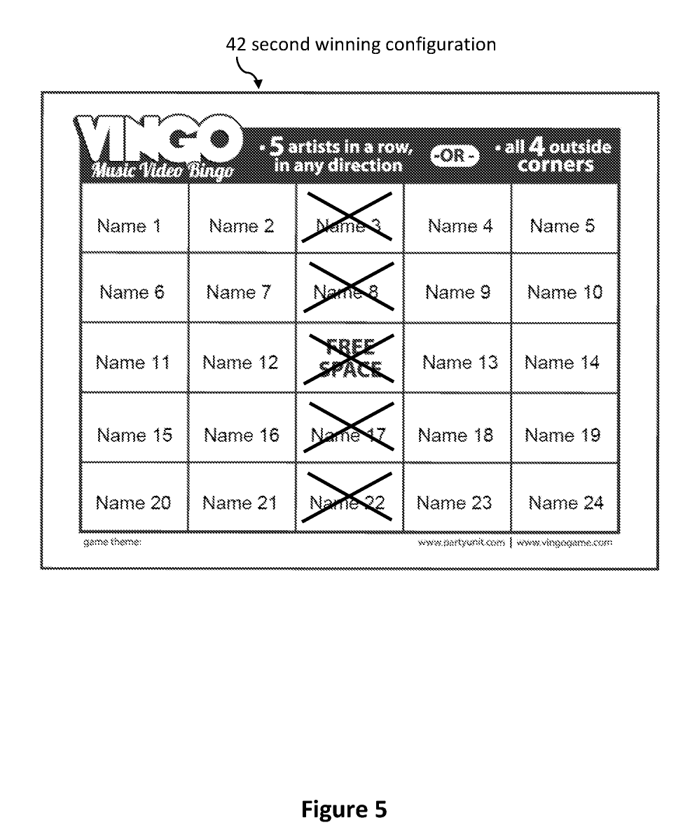

Now with collective reference to FIGS. 4-9, because the game disclosed herein is modeled after bingo, the game can be won in a number of configurations similar to traditional bingo. As shown in FIG. 4, a first winning configuration 40 is defined by any five consecutive tiles being “checked off” in any of the vertical columns, such as the one shown in FIG. 4. As shown in FIG. 5, the second winning configuration 42 is defined by five tiles being “checked off” in the middle vertical column. FIG. 5 can be distinguished from FIG. 4 because the “Free Space” is a complimentary space awarded to every player. In this regard, the player only needs to “check off” the four remaining tiles in the middle column.

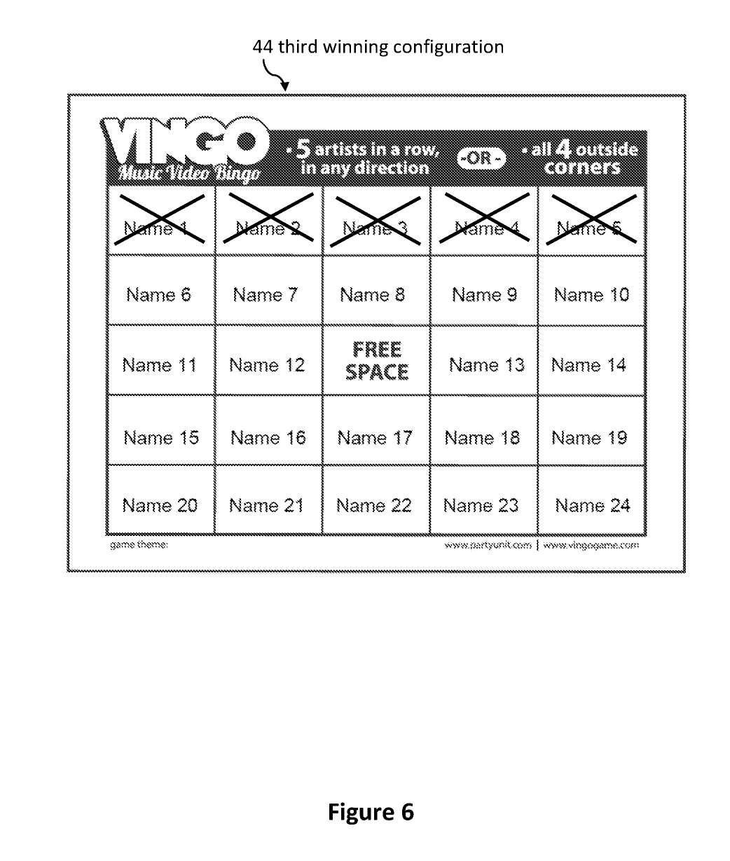

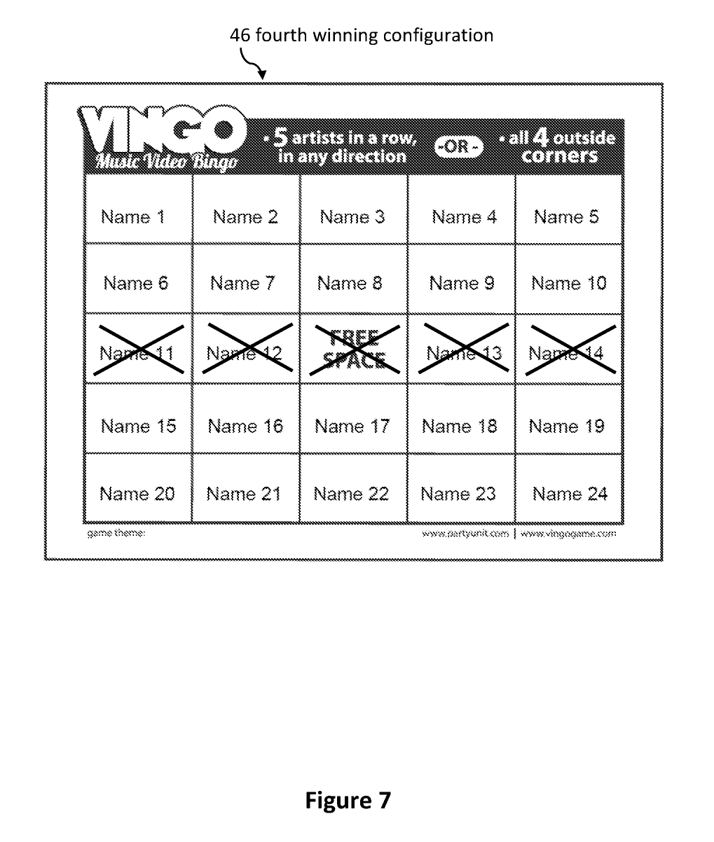

As illustrated in FIG. 6, a third winning configuration 44 is defined by any five consecutive tiles being “checked off” in any of the horizontal rows, such as the one shown in FIG. 6. As shown in FIG. 7, the fourth winning configuration 46 is defined by five tiles being “checked off” in the middle horizontal row. Similar to above, FIG. 7 can be distinguished from FIG. 6 because the “Free Space” is a complimentary space, and the player only needs to “check off” the four remaining tiles in the middle row.

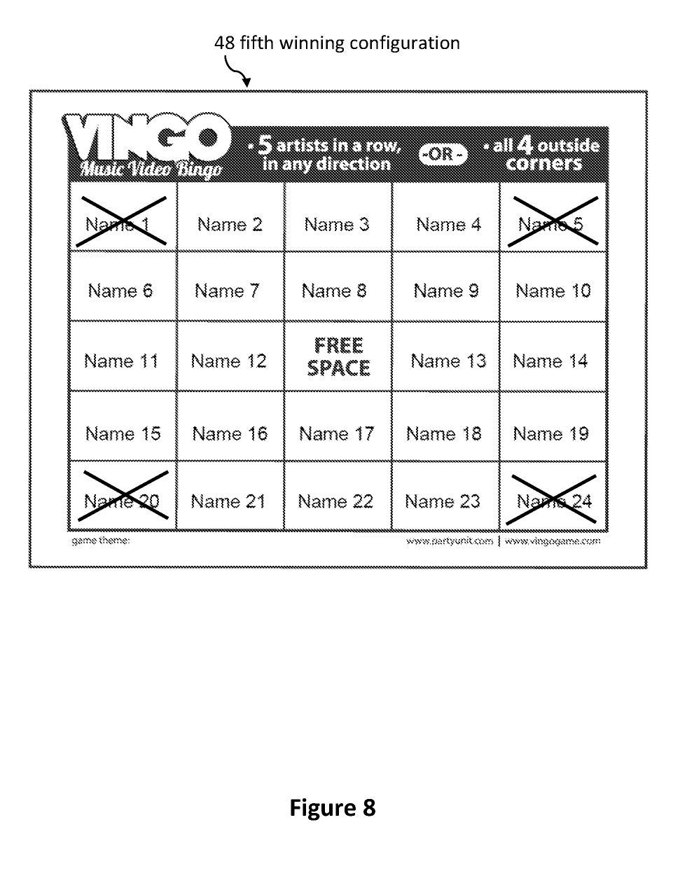

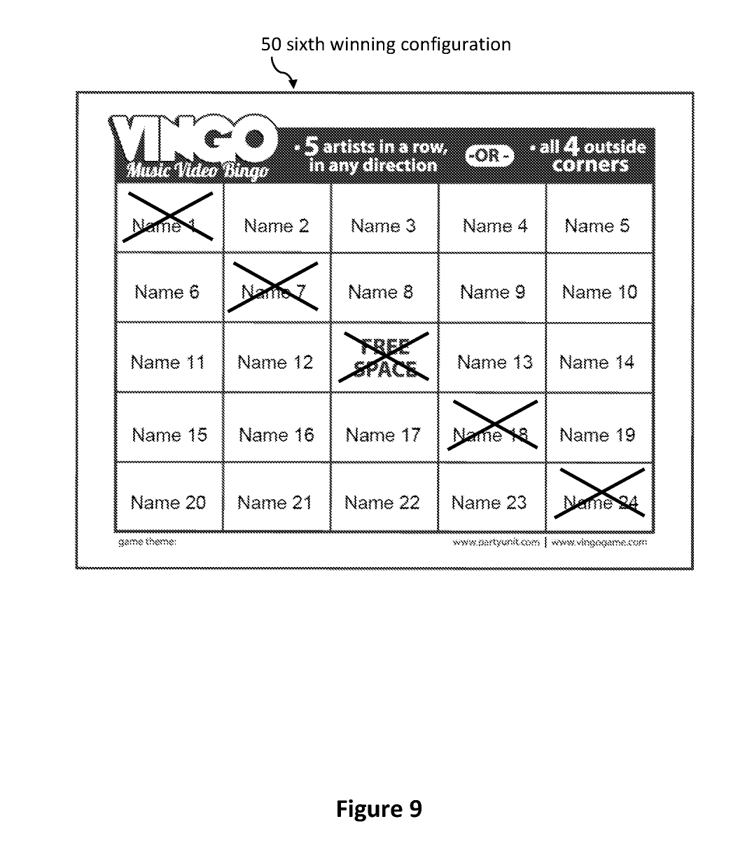

Furthermore, FIG. 8 illustrates a fifth winning configuration 48 that is defined by the four corner tiles being “checked off”. Lastly, as shown in FIG. 9, a sixth winning configuration is defined by five consecutive tiles being “checked off” in a diagonal pattern from bottom left to top right or top left to bottom right, as shown in FIG. 9.

Entertainment and Gaming Methods

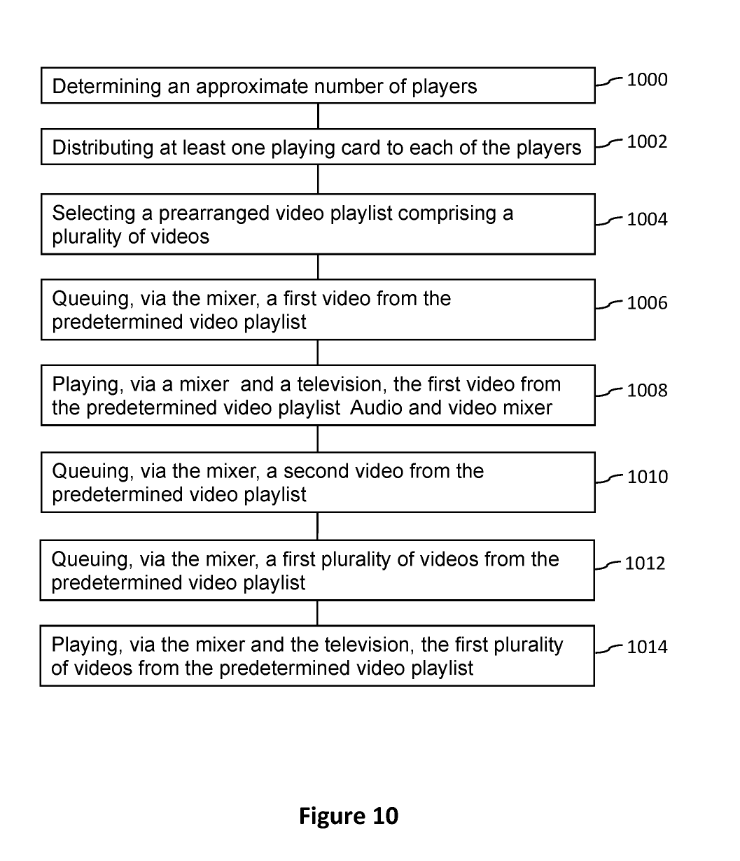

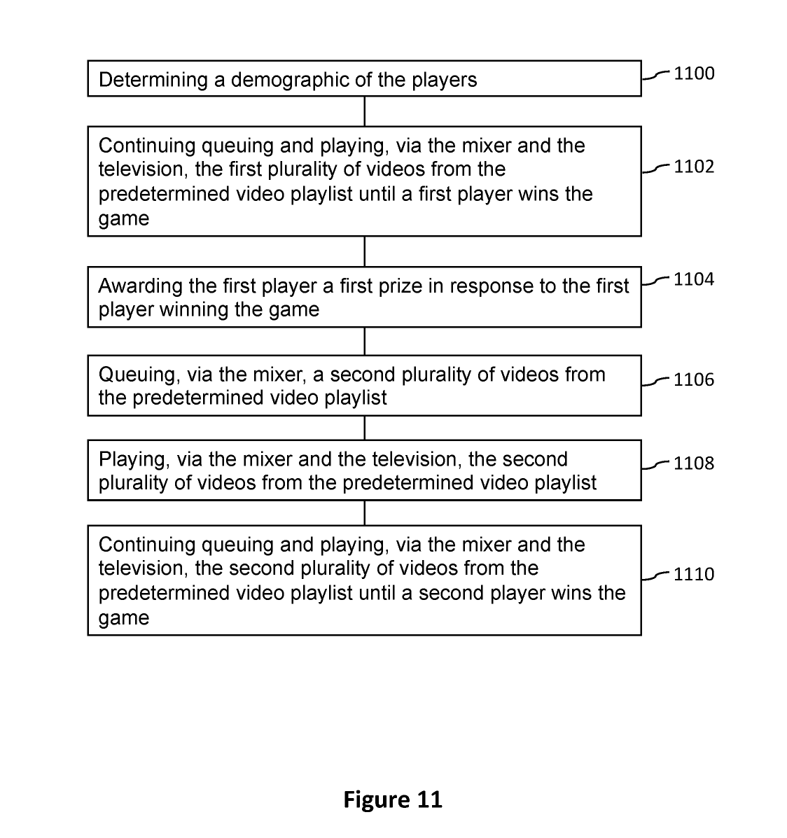

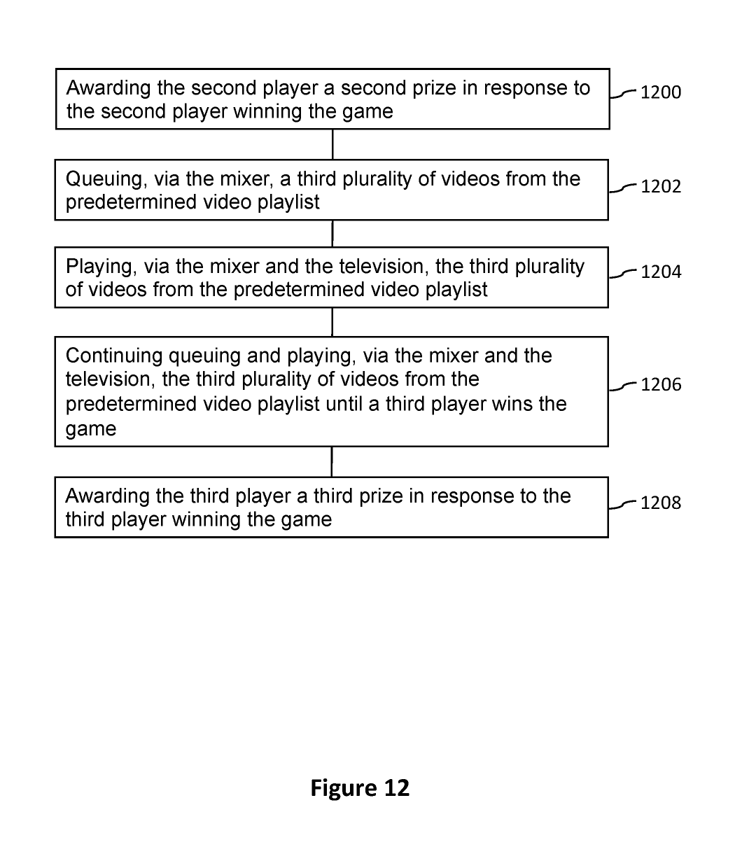

With reference to FIGS. 10-12, the entertainment and gaming systems described above can be implemented via a number of different method steps that will now be discussed. As shown in FIG. 10, the systems can be implemented via a method of preparing and playing a music video playlist that includes the steps of determining an approximate number of players (at step 1000). It should be appreciated that determining the approximate number of players can be performed by simply estimating the number of people in the crowd, or more exact methods, such as by distributing at least one playing card 26 to each of the players (at step 1002). Methods can also include selecting, via a computing device 12, a prearranged video playlist 20 comprising a plurality of music videos 22 (at step 1004).

In some embodiments, the number of music videos contained within the prearranged music video playlist 22 depends upon the approximate number of players. In this regard, the number of videos on the video playlist 20 and the selection of the playlist 20 can play a vital role to ensure that the game ends within an appropriate or predetermined amount of time. For example, if the game includes only 5-players, then the number of musician's names and/or song titles on the playing cards 26 distributed to the players is much smaller then if there were 50-players. In this regard, if the game includes only 5-players, then the selected video playlist 20 should include a smaller number of videos to be played during the game. If the selected video playlist 20 includes too many videos, then the game could take too long before a winner is revealed. This can be important because bars and restaurants schedule events to begin and end at predetermined times and they cannot have games, such as Vingo®, taking too long. In this manner, the game host can have many prearranged video playlists 20 stored on the computing device 12 to match any number of players participating in the game. For example, the host could be as precise as to 1,000 or more prearranged video playlists 20 stored on the remote computing device. This could allow the host to count and select the prearranged video playlist 20 down to the exact number of players participating. For example, if the host determines that there are 37-players then the host may select a different playlist 20 then if there were 36 or even 38-players. However, in many embodiments, the host will likely have fewer than 1,000 prearranged video playlists 20 and the host will estimate the number of players (e.g. less than 75-players, between 75 and 100-players, more than 100-players, etc.) and then select a video playlist 20 accordingly.

In addition to controlling the duration of the game by selecting prearranged music video playlists 20 that are directly related to the number of players, the host may also control the duration by distributing more or less playing cards 26 to the players. For example, if only 25-players are participating and the host wants the game to last as long as a 75-player game, the host would thereby distribute three times as many cards to each of the 25-players. Even still, if 500-players are participating, and the 500-players want to use two playing cards 26, the host may need to select a playlist for a number of players greater than 500-players, such as 1,000-players. This can thereby ensure that the game will last for a predetermined or desired duration. Generally, the host may control the game by manipulating the two factors, video playlist size and number of playing cards 26 distributed, to ensure that the game ends when the host wants the game to end. For example, the host can distribute more or less playing cards 26 to players, while using a video playlist 20 having more or less videos. The host should be aware that an increase or decrease in one of the factors will likely require an increase or decrease in the other factor to ensure that the game still ends within the predetermined amount of time.

Once the appropriate music video playlist 20 has been selected, methods can include queuing, via the mixer 14, a music first video from the predetermined video playlist 22 (at step 1006) and playing, via the mixer 14 and a display screen 16, the first video from the predetermined video playlist 20 (at step 1008). The players can thereby watch and listen to the display screen 16 to determine if the video being played is performed by a musician whose name is listed on their playing card 26 or if the video is a song title also listed on their playing card 26. If it is, then the player can “check off” the appropriate square containing the name of the musician and/or song title.

To move the game along, the game host can proceed queuing, via the mixer 14, a second music video from the predetermined music video playlist 20 to be played after the first video (at step 1010). The host may even opt to queue more than one video at once, which may include queuing, via the mixer 14, a first plurality of videos from the predetermined video playlist 20 (at step 1012). Accordingly, methods may thereby include playing, via the mixer 14 and the display screen 16, the second video and/or the first plurality of videos from the predetermined video playlist 20 (at step 1014).

In several embodiments, the game host selects the music video playlist 20 based upon the number of players in the game. Although, there are other factors that may determine which video playlist 20 the host selects. For example, methods may include determining a demographic of the players (e.g. age, sex, and the like). Based upon the demographic of the players, the host may then select a prearranged video playlist 20 having a genre of music videos commonly liked and listened to by that demographic of players (at step 1100). For example, the host may determine that the players are 21 to 25 years of age and the host thereby selects pop music or another musical genre that is more suited to the age of the players. Alternatively, the host may determine that the players are 50 to 60 years of age. In this regard, the host may select music from another genre of music, such as a specific decade (e.g. 1970s music).

Additionally, the game host will likely want the game to proceed continuously and seamlessly, in this regard, the host may perform steps, such as queuing, via the mixer 14, a first plurality of music videos from the predetermined music video playlist 20 (at step 1102). In this regard, the host can preselect and queue the first plurality of videos from the predetermined video playlist 20 and then automatically queue the first plurality of videos to continue playing, via the mixer 14 and the display screen 16, without the host's attention. The host can continue queuing music until a variety of events occur, such as a player winning the game, a predetermined amount of time elapsing, and the like.

Moreover, the game host will likely want to incent people to participate and join the game. As such, many methods may include awarding the first player a first prize in response to the first player winning the game (at step 1104).

The game host may queue and play music according to a variety of different scenarios. For example, if the typical game lasts 55 to 65 minutes, the host may queue and play enough music (e.g. the first plurality of music videos) to last for the first 55 minutes. The host may thereby queue and play a second plurality of videos, which may fill a much smaller segment of time, such as 5 to 10 minutes. In this regard, methods may include queuing, via the mixer 14, a second plurality of videos from the predetermined music video playlist 20 (at step 1106) and playing, via the mixer 14 and the display screen 16, the second plurality of videos from the predetermined video playlist 20 (at step 1108). Alternatively, the host may queue and play the music until a second winner wins the game. In this regard, the method may include continuing queuing and playing, via the mixer 14 and the display screen 12, the second plurality of videos from the predetermined video playlist 20 until a second player wins the game (at step 1110). Additionally, many methods may likely include awarding the second player a second prize in response to the second player winning the game (at step 1200).

As the game progresses closer to completion, the game host may have to be more engaged and attuned to the number of songs being played towards the end. If the game is awarding prizes to multiple winners, such as three or more winners, it is likely that the second and third winners will likely come in close sequence. In this regard, the host may queue a smaller number of songs for a third plurality of music videos. As such, methods may include queuing, via the mixer 14, a third plurality of videos from the predetermined music video playlist 20 (at step 1202) and playing, via the mixer 14 and the display screen 16, the third plurality of videos from the predetermined video playlist 20 (at step 1204). Additionally, the method may include continuing queuing and playing, via the mixer 14 and the display screen 16, the third plurality of videos from the predetermined video playlist 20 until a third player wins the game (at step 1206). Again, similar to above, many methods may include awarding the third player a third prize in response to the third player winning the game (at step 1208).

Trivia Gaming Systems and Methods

Currently, standard trivia games are quiet, boring and too specific for most players to feel like they can answer all the questions presented—much less, have even a chance at winning the game. Accordingly, this disclosure includes a trivia-like game, presented in a video format, which allows everyone to easily answer every question. This is accomplished by making the game completely subjective. Game players will be able to answer every question, make an educated guess, or select an answer from the range determined by the host.

In order to play the trivia-like game, multiple game players provide answers to the subjective questions in the form of numerical answers. Upon answering the final question, game players then add up the sum total of all their numerical answers (or of a specific grouping of their answers) to determine if they match any of the pre-set criteria to win.

To start the game, the game host will pass out answer cards and writing utensils, while also getting a feel for questions that the crowd would like to answer. The game host may then select an appropriate mix of question/slides based on player demographics. The host plays each video clip and reads the question to the players. After all questions have been asked, players will have a chance to add up the sum total of whichever questions are selected by the host (sometimes all the questions; sometimes just a select question(s)). The game players then hand their game boards to the game host, whereby the host sorts them to determine the winners.

Game players can win a prize in a variety of ways. In some embodiments, prior to the game, the game host may predetermine a total sum and assign it to a main prize. If any game player hits that number exactly with the sum of their answers, the respective player is awarded the main prize. Additionally, the game host may preselect other sums, such as a range of answers. If one or more game players sum total falls within the range, the respective game player may be awarded a subsequent, smaller prize.

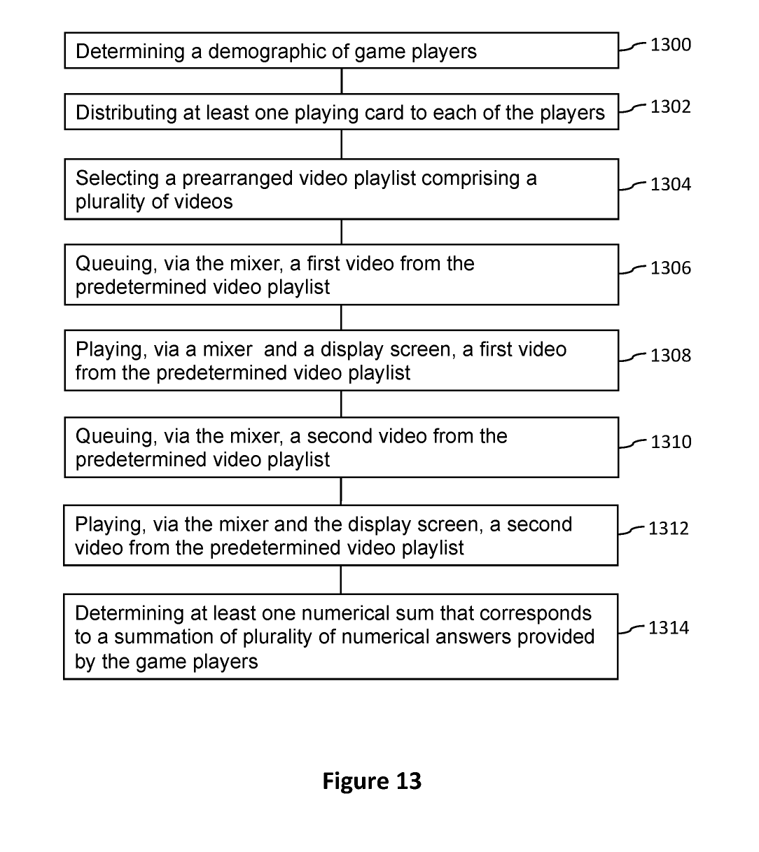

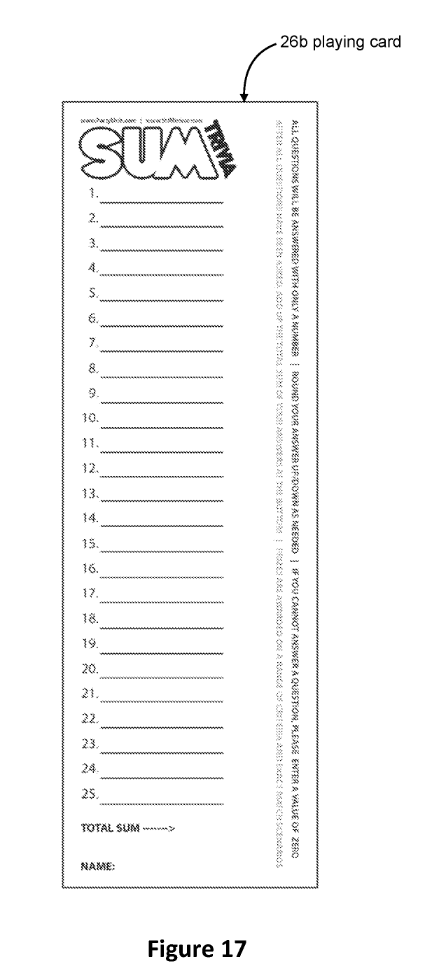

As shown in FIG. 13, the disclosure includes a method of selecting and playing a video playlist for the trivia-like game. In some embodiments, the method includes determining a demographic of game players (at step 1300) and distributing at least one playing card (as shown in FIG. 17) to each game player (at step 1302). The game players may use playing card 26b, as shown in FIG. 17, to thereby record numerical answer(s) for each question on lines 1-25. Once complete, each game player may add up the sum total and write it on the bottom to the right of “Total Sum”. The “Total Sum” may also be referred to as a numerical sum.

Methods may also include selecting, via a computing device 12, a prearranged video playlist 20 comprising a plurality of videos 22 based upon the demographic of game players (at step 1304). Methods may also include queuing, via a mixer 14, a first video from the prearranged video playlist 20 (at step 1306).

In order to visually display questions for the game players, methods may include playing, via the mixer 14 and a display screen 16, a first video from the prearranged video playlist 20 (at step 1308). The first video may represent at least a portion of a first question for the trivia-like game.

In order to keep the game flowing in an uninterrupted manner, the game host may queue a plurality of videos from the prearranged video playlist. For example, methods may include queuing, via the mixer 14, a second video from the prearranged video playlist 20 (at step 1310). It should be appreciated that the second video may represent at least a portion of a second question for the trivia-like game. Accordingly, methods may include playing, via the mixer 14 and the display screen 16, a second video from the prearranged video playlist 20 (at step 1312).

The game host may determine winners by randomly or deliberately selecting a numerical sum that determines the winner of the game. Accordingly, methods may also include determining at least one numerical sum that corresponds to a summation of the plurality of numerical answers provided by the game players (at step 1314). The numerical sum shall ensure that at least one game player will win the trivia-like game. The numerical sum may comprise any single number or range of numbers. For example, the at least one numerical sum may comprise a plurality of ranges of numerical values and/or a plurality of discrete numerical values. In some embodiments, the at least one numerical sum is equal to one discrete numerical value. For example, the game host may select the numerical sum of 500 whereby the game player(s) having a total numerical sum of 500 of all their answers wins the prize.

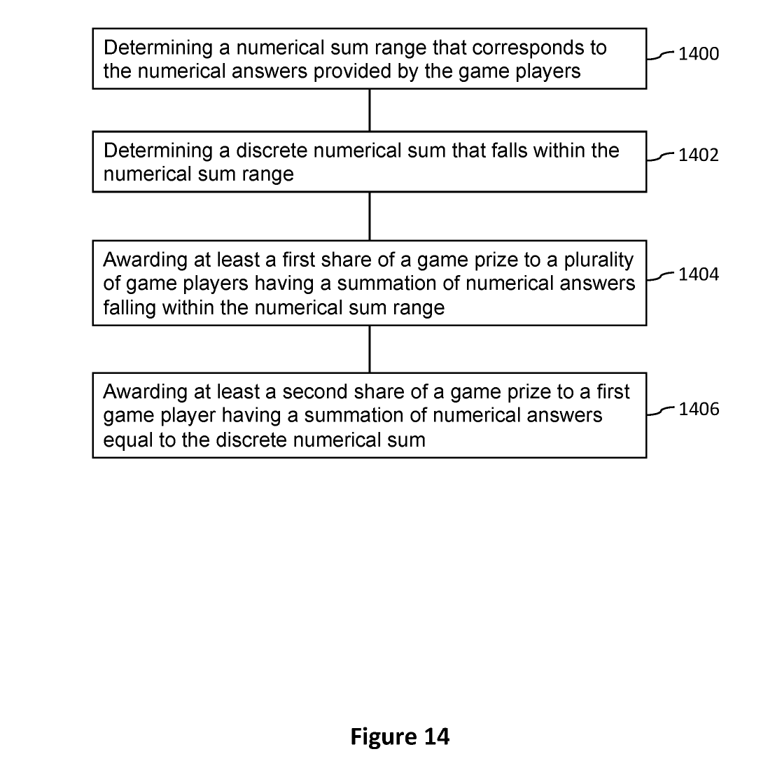

The numerical sum, as determined by the game host, may comprise a variety of numbers. For example, the game host may select a range of numbers, such as 250 to 300, and any player whose sum total falls within the range 250 to 300 wins a prize. The host may also select a discrete number, e.g. 277, whereby a jackpot prize or a larger share of a group prize is awarded to any player having the sum total 277. Accordingly, as shown in FIG. 14, methods may include determining a numerical sum range that corresponds to the numerical answers provided by the game players (at step 1400). Additionally, methods may include determining a discrete numerical sum that falls within the numerical sum range (at step 1402), perhaps for a jackpot prize. Methods may also include awarding at least a first share of a game prize to a plurality of game players having a summation of numerical answers falling within the numerical sum range (at step 1404) and awarding at least a second share of a game prize to a first game player having a summation of numerical answers equal to the discrete numerical sum (at step 1406). In some embodiments, the second share is greater than the first share.

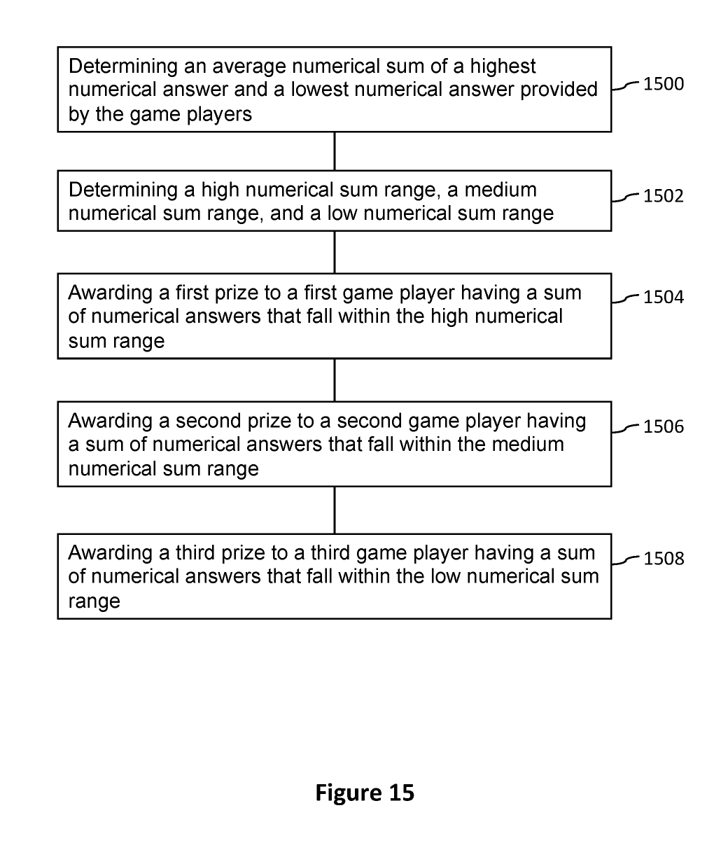

With reference to FIG. 15, in some embodiments, the at least one numerical sum is determined by calculating an average numerical sum of a highest numerical answer and a lowest numerical answer provided by the game players (at step 1500). Once this numerical sum is determined the game host may thereby select a variety of additional numerical sums based off the original sum. For example, methods may include determining a high numerical sum range, a medium numerical sum range, and a low numerical sum range that are all dependent or independent of the numerical sum determined in step 1500 (at step 1502). It should be appreciated that the high numerical sum range, the medium numerical sum range, and the low numerical sum range all may correspond to the numerical answers provided by the game players.

Accordingly, once the at least one numerical sum has been determined, prizes may be awarded to game players having numerical sums matching the numerical sum determined by the game host, or having numerical sums that fall into the range(s) as determined by the game host. For example, methods may include awarding a first prize to a first game player having a sum of numerical answers that fall within the high numerical sum range (at step 1504), awarding a second prize to a second game player having a sum of numerical answers that fall within the medium numerical sum range (at step 1506), and awarding a third prize to a third game player having a sum of numerical answers that fall within the low numerical sum range (at step 1508).

Even still, the game host may choose a numerical sum and then further manipulate the sum by applying a modifier. For example, the host may select question 4 and the numerical sum of 7. The host may then apply a multiplier of 3 yielding a numerical sum of 21 for question 4. Accordingly, any game players having the sum of 21 for question 4 would win a prize. In another example, the host may select questions 4 and 13 and the sums of 7 and 3 and applying the same or different modifiers to each numerical sum. Thus, any game player having the matching sums for questions 4 and 13 would win. It should be appreciated that these are just a few of many examples for how the modifier may be implemented.

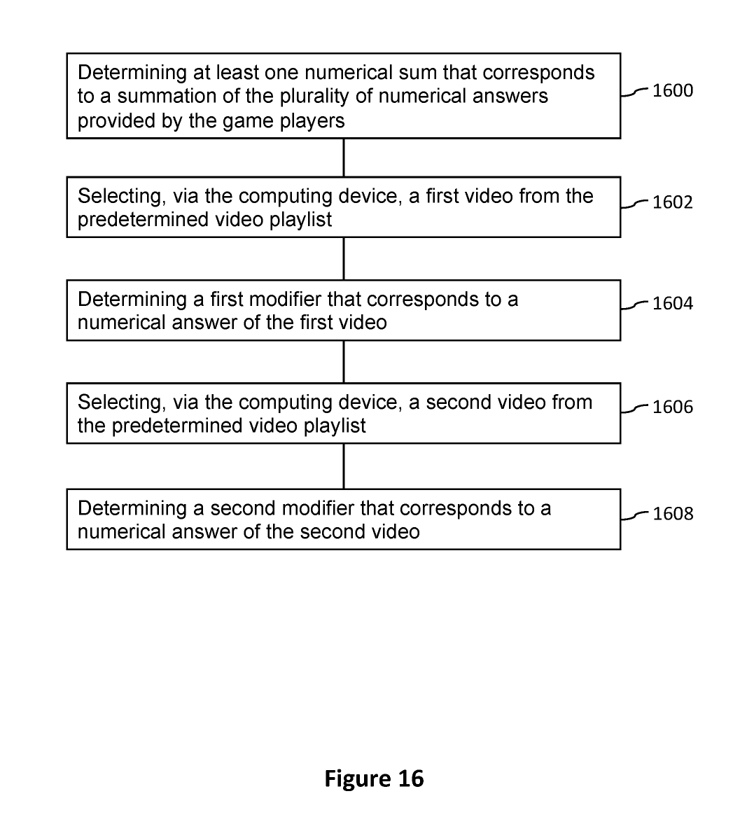

In practice and with reference to FIG. 16, methods may thereby include determining at least one numerical sum that corresponds to a summation of the plurality of numerical answers provided by the game players (at step 1600). Additionally, methods may include selecting, via the computing device 12, a first video from the prearranged video playlist 20 (at step 1602) and determining a first modifier that corresponds to a numerical answer of the first video (at step 1604). The first modifier may be arranged and configured to eliminate at least one game player from eligibility for a prize. Methods may also include selecting, via the computing device 12, a second video from the prearranged video playlist 20 (at step 1606) and determining a second modifier that corresponds to a numerical answer of the second video. Similar to the first modifier, the second modifier may be arranged and configured to eliminate at least one game player from eligibility for the prize.

Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A method of selecting and playing a video playlist for a trivia-like game, comprising:
determining a demographic of game players;
distributing at least one playing card to each game player;
selecting, via a computing device, a prearranged video playlist comprising a plurality of videos based upon the demographic of game players; and
playing, via a mixer and a display screen, a first video from the prearranged video playlist, wherein the first video represents at least a portion of a first question for the trivia-like game.

2. The method of claim 1, further comprising queuing, via the mixer, a first video from the prearranged video playlist.

3. The method of claim 2, further comprising queuing, via the mixer, a second video from the prearranged video playlist.

4. The method of claim 3, further comprising playing, via the mixer and the display screen, a second video from the prearranged video playlist, wherein the second video represents at least a portion of a second question for the trivia-like game.

5. The method of claim 1, wherein the plurality of questions cause the game players to provide a plurality of numerical answers.

6. The method of claim 5, further comprising determining at least one numerical sum that corresponds to a summation of the plurality of numerical answers provided by the game players.

7. The method of claim 6, wherein the at least one numerical sum ensures that at least one game player will win the trivia-like game.

8. The method of claim 6, wherein the at least one numerical sum comprises at least one of a plurality of ranges of numerical values and a plurality of discrete numerical values.

9. The method of claim 8, wherein the at least one numerical sum is equal to a plurality of discrete numerical values.

10. The method of claim 8, wherein the at least one numerical sum is equal to one discrete numerical value.

11. The method of claim 6, wherein determining the at least one numerical sum comprises determining an average numerical sum of a highest numerical answer and a lowest numerical answer provided by the game players.

12. The method of claim 11, further comprising determining a high numerical sum range, a medium numerical sum range, and a low numerical sum range, wherein the high numerical sum range, the medium numerical sum range, and the low numerical sum range all correspond to the numerical answers provided by the game players.

13. The method of claim 12, further comprising:
awarding a first prize to a first game player having a sum of numerical answers that fall within the high numerical sum range;
awarding a second prize to a second game player having a sum of numerical answers that fall within the medium numerical sum range; and
awarding a third prize to a third game player having a sum of numerical answers that fall within the low numerical sum range.

14. The method of claim 11, further comprising determining a numerical sum range that corresponds to the numerical answers provided by the game players.

15. The method of claim 14, further comprising determining a discrete numerical sum that falls within the numerical sum range.

16. The method of claim 15, further comprising:
awarding at least a first share of a game prize to a plurality of game players having a summation of numerical answers falling within the numerical sum range; and
awarding at least a second share of a game prize to a first game player having a summation of numerical answers equal to the discrete numerical sum, wherein the second share is greater than the first share.

17. The method of claim 6, further comprising selecting, via the computing device, a first video from the prearranged video playlist, wherein the first video represents at least a portion of a first question for the trivia-like game.

18. The method of claim 17, further comprising determining a first modifier that corresponds to a numerical answer of the first video, wherein the first modifier is arranged and configured to eliminate at least one game player from eligibility for a prize.

19. The method of claim 18, further comprising selecting, via the computing device, a second video from the prearranged video playlist, wherein the second video represents at least a portion of a second question for the trivia-like game.

20. The method of claim 19, further comprising determining a second modifier that corresponds to a numerical answer of the second video, wherein the second modifier is arranged and configured to eliminate at least one game player from eligibility for the prize.
